(19) United States
(12) Patent Application Publication
(10) Pub. No.: US 2015/0334241 A1
(43) Pub. Date: Nov. 19, 2015

(54) Real-Time Monitoring/Interrupting of Voicemail Message Recording

(71) Applicant: TELEFONAKTIEBOLAGET L M ERICSSON (PUBL), Stockholm (SE)

(72) Inventor: Rogier August Caspar Joseph Noldus, Goirle (NL)

(21) Appl. No.: 14/652,162

(22) PCT Filed: Dec. 21, 2012
(86) PCT No.: PCT/EP2012/076830

§ 371 Date: Jun. 15, 2015

(51) Int. Cl. H04M 3/533; H04L 29/06

(52) U.S. Cl. CPC H04M 3/533; H04L 65/4007

(57) ABSTRACT

The invention relates to a method of listening, in real-time and by message recipient, of voicemail messages being recorded. The method comprises receiving a request for establishment of a first connection with a calling party terminal. In response to this request, the method comprises sending a command for establishing this first connection between the calling party terminal and a storage entity, i. e., a voicemail server. This command comprises a parameter for triggering the establishment of a second connection. The method also comprises receiving via this second connection information being transmitted over the first connection, i. e., the message being recorded.

### TECHNICAL FIELD

The present invention relates to an apparatus and method for enhancing communication service.

### BACKGROUND

Telephony services are nowadays ubiquitous. Telephony services can be provided by a Public Land Mobile Network (“PLMN”), a telecommunications network operating in accordance with for example the GSM or 3G standards. They can also be provided by a network with IP Multimedia Subsystem (“IMS”) architecture. In addition to networks providing services for only voice,

MultiMediaTelephony (“MMTel”) are now also common providing “multi media” service, including, but not limited to voice services, video services and messaging services. MMTel can be provided by networks operating in accordance with Long Term Evolution (“LTE”) which is a standard for wireless communication, but also by wired telecommunications networks.

When a subscriber of a telephony service, using a User Equipment, UE, such as a communication terminal or “terminal” in short, receives a call, in which case that subscriber takes the role of ‘called party’, the subscriber, i.e. the called party, may not be in a position to answer the call, for example when the called party is in a meeting or in conversation with somebody. Also, the called party may simply not want to answer a call from a particular calling party, for some reason. The called party may in such a case “push the incoming call away”, also known as “rejecting the call”. This is also known as generating a User-Determined User Busy (UDUB) message. In such a case the call is forwarded to the forwarding destination that is configured in the telephony profile of the called party. The call will, in the case of call forwarding, often be routed to a voicemail system, as that is the forwarding destination that is normally programmed in the telephony profile of a telephony subscriber. When a called party has rejected an incoming call, that called party must wait until the calling party has finished recording their message and then contact the voicemail system in order to be able to listen to the recorded message. Thus, in the case of rejecting a call, the call is forwarded to the previously administered forwarding destination for the Busy condition. The forwarding destination is identified by means of a forwarded-to number.

In addition to forwarding the call each time to the same forwarding destination, a telephony service may provide a service called “Call deflection”. Call deflection is a standardized supplementary service in both GSM/3G and IMS (MMTel). Call deflection means that the called party can “push an incoming call away” and provide ad hoc the forwarding destination number. So, in such a situation the call is not forwarded to a pre-configured forwarding destination identified by means of a forwarded-to number, but to a destination identified by a number that is provided by the called party ad hoc, i.e. when deciding not to answer the call, but to forward the call to an alternative destination. The alternative destination may be a voicemail system, but the called party may have several voicemail systems at their disposal to which they can forward calls, for instance one for business use and one for private use. They may decide on a case by case basis, for instance as a function of what calling party is trying to contact them, to forward the call to their business voicemail system or their private voicemail system. Anyway, independent of which voicemail system is chosen, in such a case as well, the called party must wait until the calling party has finished recording their message and then call into the voicemail system concerned to listen to the recorded message.

In the case of GSM/3G networks, call deflection entails that the called party sends an indication back towards a telephony server, called a mobile switching centre (“MSC”), to indicate that this incoming call shall be forwarded to a particular alternative destination. Call deflection entails specifically that this particular alternative destination is provided ad hoc, by the called party. The called party must include in this deflection request the required alternative destination.

It is possible for the called party to provide as the particular alternative destination the number of their voicemail system. As such, the call is deflected to the voicemail system of the called party. The method of deflecting to voicemail system can, furthermore, be implemented as a special case of call deflection. The call rejection message, transmitted from the called party to the MSC, contains in this case an indication that the call shall be deflected to a specific, preconfigured destination, namely the number of the voicemail system of the called party.

The above described process will now be described in relation to FIG. 1. In FIG. 1a, during a first step 101 a called party receives a request for establishment of a call from a calling party. If the called party decides, in a subsequent step 103 to answer the call, a call is established in a step 105 between the calling party and the called party. However, if the called party during the subsequent step 103 decides not to answer the call of the calling party, during a step 107 the calling party can leave a voicemail for the called party in a voicemail system.

When no voicemail has been left, there is no need for additional action by the called party. However, if it transpires during a step 109 that a message has been left, as shown in FIG. 1b, the called party needs to call the voicemail system in order to learn about the contents of the voicemail, step 110.

The above described process has disadvantages.

For instance, whereas the called party cannot answer the call or does not want to answer the call, it is not possible to note the contents of the voicemail that the calling party is leaving behind in the voicemail system.

In other words, the called party may be able to and willing to “listen” to the calling party but the called party cannot or does not want to talk to the calling party at that very moment. In this case the called party has to wait until a missed-call message or a voicemail notification arrives (typically in the form of an SMS), indicating that a particular calling party called and indicating that the calling party has left a voicemail.

Additional calls need to be established: at least one call to the voicemail system to learn about the contents of the voice mail and, if applicable, another call setup to the calling party.

Thus, in addition to being cumbersome to a called party the current method also has the disadvantage of increasing network resource usage.

### SUMMARY

It is an object to obviate at least some of the above disadvantages and provide an improved method and apparatus for telecommunications.

According to an aspect of the invention there is provided a method for enhancing communication service in a called party terminal. The method comprises receiving a request for establishment of a first connection with a calling party terminal. In response to this request, the method comprises sending a command for establishing this first connection between the calling party terminal and a storage entity. This command comprises a parameter for triggering the establishment of a second connection. The method also comprises receiving via this second connection information being transmitted over the first connection.

According to another aspect of the invention there is provided a called party terminal comprising a receiving unit. This receiving unit is adapted to receive a request for establishment of a first connection with a calling party terminal. The called party terminal also comprises a processing unit. The processing unit is adapted to send, in response to receiving the request, a command for establishing the first connection between the calling party terminal and a storage entity. This command comprises a parameter for triggering the establishment of a second connection. The receiving unit is further adapted to receive via this second connection information being transmitted over the first connection.

According to another aspect of the invention there is provided a method comprising receiving a command for establishing a first connection between a calling party terminal and a storage entity. This command comprises a parameter for triggering the establishment of a second connection. The method also comprises establishing the first connection and establishing the second connection between the calling party terminal and a called party terminal, such that the called party terminal can receive via the second connection information being transmitted over the first connection.

According to another aspect of the invention there is provided an application server comprising a receiving unit adapted to receive a command for establishing a first connection between a calling party terminal and a storage entity. This command comprises a parameter for triggering the establishment of a second connection. The application server also comprises a processing unit adapted to establish the first connection. The processing unit is further adapted to establish the second connection between the calling party terminal and a called party terminal, such that the called party terminal can receive via the second connection information being transmitted over the first connection.

The methods, terminal and server described above have among others as advantages that they allow a telephony subscriber or user to listen in real-time to a voicemail that is being recorded. This can be useful when the user does not want to answer a call, but still wishes to know immediately what voicemail is left behind, so that the user can decide whether a call back is required.

According to an embodiment of the invention, the method as referred to above further comprises receiving from the called party terminal a second command for changing the second connection into a bidirectional communication between the called party terminal and the calling party terminal. This method also comprises establishing the bidirectional communication.

This embodiment has as an advantage that, whilst listening to the voicemail recording from the calling party, it allows the user to barge-in to the call. Effectively, this enables a user to answer the call even though the calling party had already started to record a voicemail.

The embodiments claimed in this application have further the advantage of providing added value to telephony services, as for example offered by the MMTel-AS. MMTel-AS is the 3GPP standardised facilitator of multimedia telephony within the IMS network. The node in which MMTel-AS is embodied is commonly referred to as Telephony application server (TAS).

The solution can be offered as functionality in TAS, in combination with terminal applications. There is no strict requirement on the system: such a system can have many possible configurations. However, if a multimedia telephony server comprises also the voicemail functionality (as opposed to voicemail functionality being contained in a separate node), then that allows for further improvement, such as the inhibition of storing the recorded voicemail message in the case of a called party barge-in.

### BRIEF DESCRIPTION OF THE DRAWINGS

For a better understanding of the present invention, and to show more clearly how it may be carried into effect, reference will now be made, by way of example only, to the following drawings in which:

FIGS. 1a and 1b show flowcharts illustrating the steps for recording and retrieving a voice mail message;

FIG. 2 shows a flowchart illustrating a method according to a first embodiment of the invention;

FIG. 3 shows a user equipment device according to the first embodiment of the invention;

FIG. 4 shows a flowchart illustrating steps according to the first embodiment of the invention;

FIG. 5 shows an application server according to the first embodiment of the invention;

FIG. 6 shows the signalling and data paths in a system in which the method according to the first embodiment the invention can be carried out;

FIG. 7 shows one of the nodes shown in the system of FIG. 2 in more detail;

FIG. 8 shows a flowchart illustrating in detail steps according to the first embodiment of the invention;

FIG. 9 shows a possible screen layout for a user equipment device implementing a second embodiment of the invention;

FIG. 10 shows a possible screen layout for a user equipment device implementing a third embodiment of the invention;

FIGS. 11a to 11c illustrate a fourth embodiment of the present invention; and

FIG. 12 shows a flowchart illustrating steps according to a fifth embodiment of the invention.

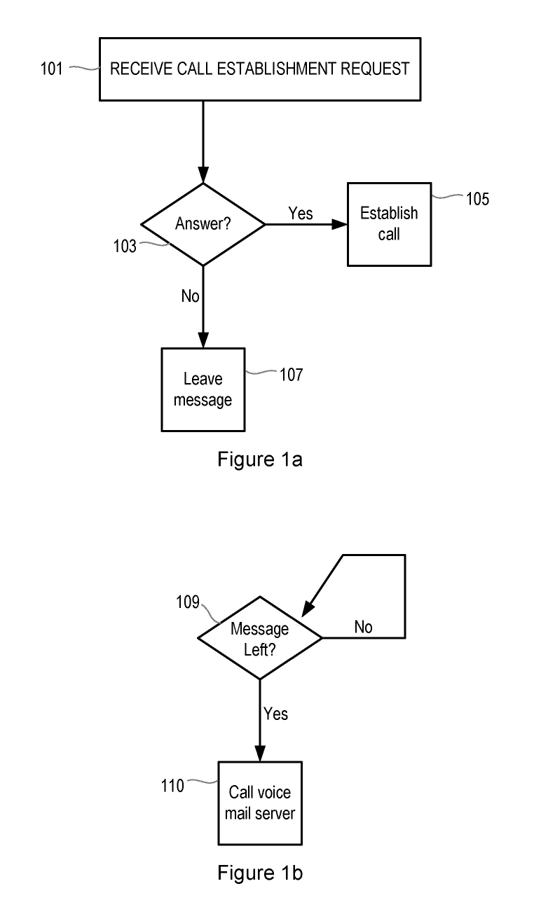

### DETAILED DESCRIPTION

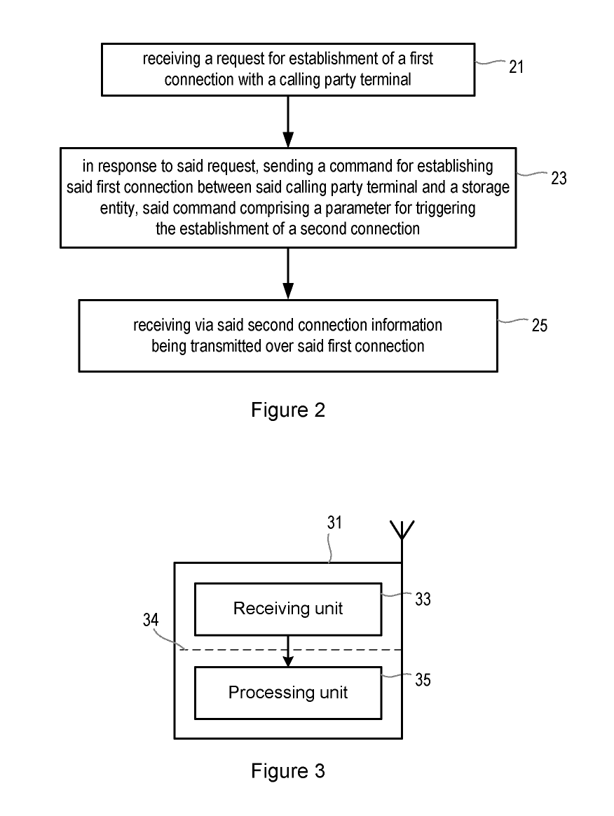

A method for enhancing communication service in a called terminal according to an embodiment of the invention is described in connection with FIG. 2. The method may be implemented in a user equipment device such as a mobile terminal or “terminal” in short. Such a terminal can also be referred to as a cell phone. This method can also be implemented in a personal digital assistant (“PDA”) or any other device or terminal with telecommunications functionality. The method may also be implemented in a fixed terminal. It should again be noted that this may also be referred to as “terminal” in short.

In this application a “party” is meant to refer both to a person or process (such as a software routine) using a terminal (a physical device also referred to as a user equipment device) as well as to the terminal or user equipment device itself, in isolation. When such a “party” or “terminal” or “user equipment device” is at the origin of a request for establishment of a connection with another “party” or “terminal” or “user equipment device”, the former is referred to as “calling party” or “calling terminal” or “calling party terminal” and the latter is referred to as a “called party” or “called terminal” or “called party terminal” in this application.

The method comprises a step 21 of receiving a request for establishment of a first connection with a calling party. The first connection may be a voice call but also a video call involving the exchange of multi media elements.

In response to the request, the method comprises during a step 23 sending a command for establishing the first connection between the calling party and a storage entity. The storage entity may be a voice mail system or voice mail server comprising a suitably dimensioned database for storing voicemail messages. However, in the case of a video call, the voice mail system will also have some memory capacity to store messages containing video and or multi media elements. The voicemail system or voicemail server may be a stand-alone system or may be integrated in a telephony server. The command also comprises a parameter for triggering the establishment of a second connection. Again, this second connection can be a voice call but also a video call involving the exchange of multi media elements with a called party. The second connection is a connection established between the calling party and the called party.

During a subsequent step 25, the method comprises receiving via the second connection information being transmitted over the first connection. Specifically, information being transmitted from calling party towards voicemail system. The information the called party receives is the same as the information that the calling party is transmitting to the storage entity. A typical example of such information would be a voicemail which the calling party is in the process of recording for the called party. It should be noted that the establishment of the first connection can be before, at substantially the same time or after the establishment of the second connection.

FIG. 3 shows a user equipment device 31, for example a mobile terminal or cell phone or a personal digital assistant (“PDA”) or any other device or terminal with telecommunications functionality in which the method described in connection with FIG. 2 can be carried out.

The user equipment device 31 comprises a receiving unit 33 adapted to receive a request for establishment of a first connection with a calling party, and a processing unit 35 adapted to send, in response to receiving the request, a command for establishing the first connection between the calling party and a storage entity. This command comprises a parameter for triggering the establishment of a second connection.

The receiving unit 33 is further adapted to receive via the second connection information being transmitted over the first connection. The user equipment device 31 of FIG. 3 is typically the kind of user equipment device used by the calling party and/or the called party.

According to one embodiment, the user equipment device 31 works in the following way. When the user equipment device 31 is powered on, but not currently involved in any communication, i.e. the user equipment is in standby mode, the receiving unit 33 is waiting for a request for establishment of a first connection with a calling party to arrive. If such a request is received, the receiving unit 33 forwards the request to the processing unit 35 which, in response to receiving said request, sends a command for establishing the first connection between the calling party and a storage entity. As pointed out above the storage entity can be a voicemail system and can have the capacity to store messages with multi media content. The first connection is therefore a connection which is established between the calling party and the storage entity for recording a message for the called party. The command also comprises a parameter for triggering the establishment of a second connection. The second connection is established between a calling party and the called party, for example a user of the user equipment device 31. When in operation, the receiving unit 33 receives over the second connection information transmitted from the calling party to the storage entity while a transmission of that information over said first connection is in progress. This enables the called party to obtain this information while it is being transmitted to the storage entity (for example listening to a voice mail message as it is being left by the calling party on the voice mail system).

Although the processing unit 35 and the receiving unit 33 have been drawn in a single user equipment device 31 they may be located in different, separate user equipment devices. This aspect is illustrated by the dashed line referenced 34.

In such a case, the command may be issued by a processing unit 35 in a one user equipment device and the information may be received by a receiving unit 33 in another user equipment device.

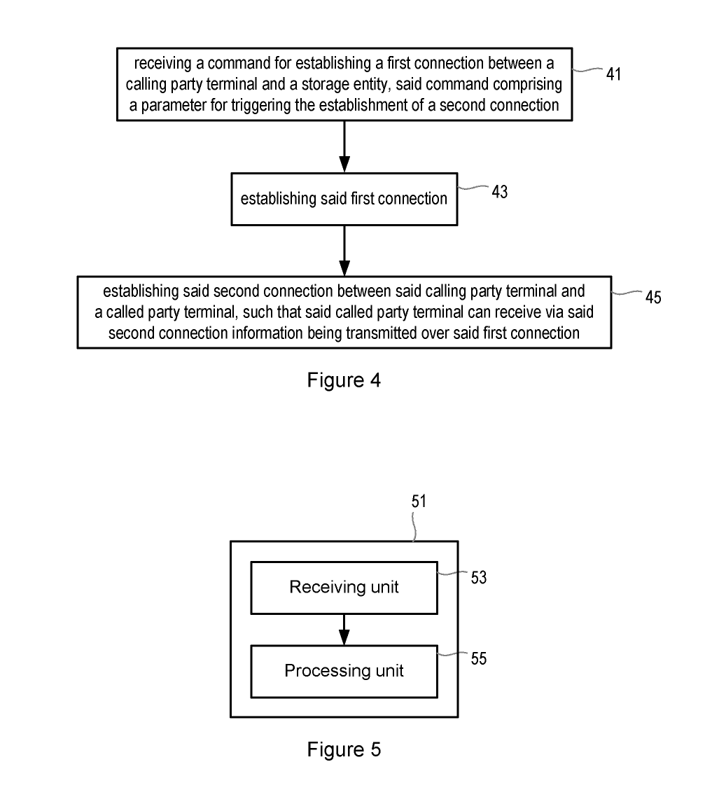

A network node, for instance an application server, can be involved in establishing the connections described above as will be explained using the flowchart shown in FIG. 4. Such an application server can implement a method that comprises receiving during a step 41 a command for establishing a first connection between a calling party and a storage entity. The command comprises a parameter for triggering the establishment of a second connection. During a step 43 the first connection is established. The application server also establishes the second connection with a called party, which during a step 45 is established between the calling party and the called party. This enables the called party to receive via said second connection information being transmitted over said first connection.

FIG. 5 shows an example of an application server 51 according to an embodiment of the invention, which may perform the above described method in connection with FIG. 4. Such an application server 51 comprises a receiving unit 53 and a processing unit 55. The receiving unit 53 is adapted to receive a command for establishing a first connection between a calling party and a storage entity. This command also comprises a parameter for triggering the establishment of a second connection. The processing unit 55 is adapted to establish the first connection with a called terminal. In addition, the processing unit 55 is adapted to establish the second connection between the calling party and the called terminal. As disclosed above, in this way the called terminal can receive via the second connection information being transmitted over the first connection.

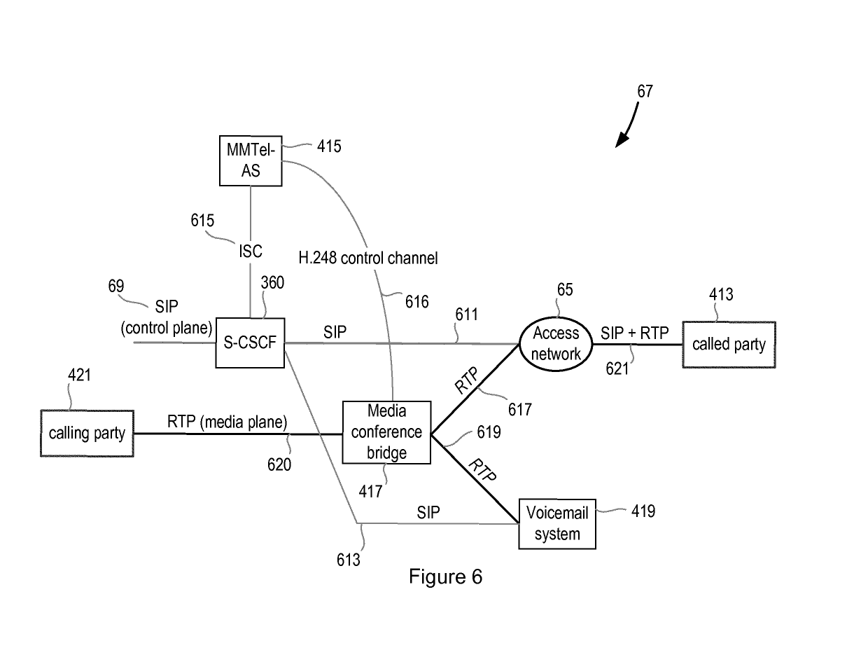

FIG. 6 shows an example of architecture of a network 67 in which the above disclosed methods may be implemented. The network shown in FIG. 6 is based on IMS and may be used to provide MMTel. However, the methods as disclosed above may also be implemented in a GSM network, without deviating from the object of the invention, or networks based on other telecommunication standards. The person skilled in the art will be familiar with entities used to provide MMTel such as the service centralization and continuity application server (“SCC-AS”), the Home Subscriber Server (“HSS”), the Interrogating Call Session Control Function (“I-CSCF”), the Proxy Call Session Control Function (“P-CSCF”) and other entities. Therefore and in order not to obscure the following explanation they will not be described here in detail. FIG. 6 shows however an MMTel Application server 415 (“MMTel-AS”). The MMTel-AS 415 is linked to a Serving Call Session Control Function (“S-CSCF”) 360 via a standardized IMS Service Control (ISC) interface 615. The S-CSCF 360 is linked to a SIP control plane 69 and has a signalling link 611 with an access network 65 as well as a signalling link 613 with a voicemail system 419. The network 67 also comprises a media conference bridge 417 which has a signalling link 616 (for example a H.248 control channel) with the MMTel-AS 415 as well as a user plane link 620 with a calling party 421, a user plane link 617 with the access network 65 and a user plane link 619 with the voice mail system 419. A called party 413 has both user plane and control plane links 621 with the access network 65.

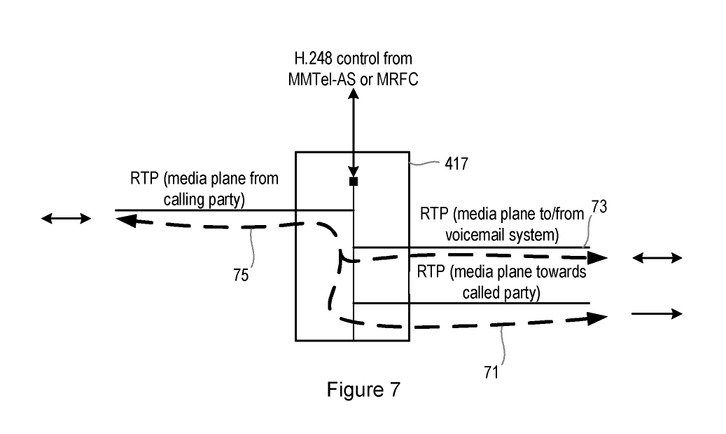

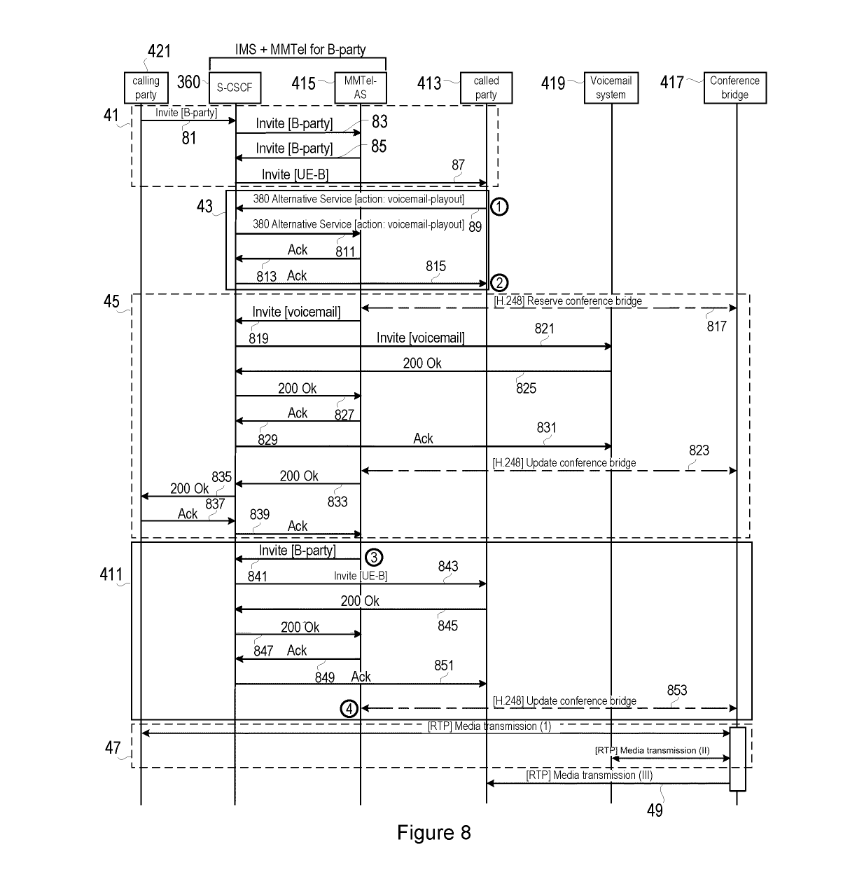

During operation of the network 67, signalling data is transported over the signalling links in the control plane using the session initiation protocol (“SIP”). User data is transported in the user plane by means of the Real-time Transport Protocol (“RTP”). The media conference bridge 417 can be used to establish the first and second connections described in the embodiments above, as will be explained below in connection with FIGS. 7 and 8.

FIG. 7 shows the media conference bridge 417 from FIG. 6 in greater detail. FIG. 7 shows the case whereby the media conference bridge 417 is controlled directly by the MMTel-AS 415. An alternative implementation is that the media conference bridge 417 is controlled by a media resource function controller (“MRFC”), whereby SIP signalling is used between the S-CSCF 360 and the MRFC and whereby the MRFC in turn is controlled by the MMTel-AS 415. Such deployment is an implementation option and would not deviate from the essence of the invention.

In both cases, the media conference bridge 417 applies user plane (voice) mixing as, i.e. mixes (this information stream is referenced 71 in FIG. 7) the speech originating from the voicemail system 419 (information stream referenced 73) and the speech from the calling party 421 (information stream referenced 75 in FIG. 7).

This is also referred to as establishing a three party call, where the three parties involved are the calling party 421, the called party 413 and the voicemail system 419. The method of the present invention differs from a regular three party call during such a mode of operation, in the sense that the connection with the called party's terminal, referred to as second connection, transfers media in one direction only, namely media from calling party to called party.

FIG. 8 illustrates with a call flow diagram a method according to an embodiment of the invention based on a realization as an MMTel service. The method begins with the calling party or calling party 421 issuing, in a step 81, a SIP Invite message comprising an identifier for the called party or called terminal 413. The identifier can be “B-party” or “UE-B”. This SIP Invite message arrives at the S-CSCF 360 and is routed, in a step 83, from the S-CSCF 360 to the MMTel-AS 415. In response to receiving the Invite message, the MMTel AS 415 sends, in a step 85, a SIP Invite message back to the S-CSCF 360. The

SIP Invite message is then routed, in a step 87, from the S-CSCF 360 to the called party 413 and received by the latter.

This SIP invite message from the MMTel-AS 415 to the called party 413, represents an attempt by the calling party 421 to establish a call with the called party 413.

The called party 413 thus receives this SIP Invite message on their terminal (for instance a SIP phone). The called party 413 decides not to take the call and applies an action, also referred to below as “Direct to voicemail with playout” to deflect the call to the voicemail system 419, the deflection being a deflection with real-time playout. Hereto, the called party 413 issues, in a step 89, a SIP final response code 380 Alternative Service message. More information about this message can be found in IETF RFC 3261, section 21.3.5. The SIP final response code 380 Alternative Service message contains an instruction in the message body, indicating to the receiver of this message what action is expected. According to an embodiment of the invention this SIP final response code 380 Alternative Service message contains an indication that a voicemail with playout is required. In this case the receiver is the S-CSCF 360 which in its turn routes, in a step 811, the SIP final response code 380 Alternative Service message to the MMTel-AS 415. The action expected by the called party 413 is that this call is deflected to their pre-configured voicemail number and that they get real-time playout of the voicemail. To this end, the body of the SIP final response code 380 Alternative Service message contains the instruction ‘action: voicemail-playout’.

When the called party 413 uses the option ‘Direct to voicemail with playout’, it includes a random token in the SIP final response code 380 Alternative Service message sent in steps 89 and 811 in FIG. 8. The MMTel-AS 415 includes this random token subsequently in the SIP Invite message sent in steps 841 and 843 which will be discussed in more detail below. As a deployment option the MMTel-AS 415 includes a special indication (for example a SIP header parameter) in the “From:” header or in the “To:” header of this SIP Invite message or adds a special R-URI parameter (where R-URI Request uniform resource identifier) to it. The called party 413 can then determine from the token in the SIP Invite message that this is a voicemail playout call as requested earlier on by the called party 413, namely in step 89.

Reception of the SIP final response code 380 Alternative Service message by the MMTel-AS 415 is acknowledged, in a step 813, to the S-CSCF 360. And the S-CSCF 360 sends, in a step 815, the acknowledgement of the reception of the SIP final response code 380 Alternative Service message to the called party 413.

The transmission of the SIP final response code 380 Alternative Service message by the called party 413, followed by receiving the acknowledgement, terminates the SIP Invite transaction for the called party 413.

The MMTel-AS 415 receives the SIP final response code 380 Alternative Service message during step 811, including the instruction ‘action: voicemail-playout’. The MMTel-AS 415 will now, in response to receiving the SIP final response code 380 Alternative Service message take action. Notably, the MMTel-AS 415 will connect the calling party 421 to the voicemail system 419. The user plane of this connection to the voicemail system 419 is established through the media conference bridge 417. The establishment of this connection between the calling party 421 and the voicemail system 419 involves the exchange of further SIP messages as will be explained in the following.

The MMTel-AS 415 reserves in a step 817 resources of the media conference bridge 417 before establishing the SIP session towards the voicemail 419.

The MMTel-AS 415 then sends, in a step 819, a SIP Invite message to the S-CSCF 360. The S-CSCF 360 routes, in a step 821, this SIP Invite message to the voicemail system 419. When the voicemail system 419 has answered the call, the MMTel-AS 415 has to update, in a step 823, the media conference bridge 417 with user plane information of the voicemail system 419. Answering the call, means in this context that the voicemail system 419 sends, in a step 825, a SIP 200 Ok message to the S-CSCF 360 which forwards, in a step 827, this SIP 200 Ok message to the MMTel-AS 415 and that the reception of the SIP 200 Ok message is acknowledged, i.e. that a SIP Ack message is sent, in a step 829, from the MMTel-AS 415 to the S-CSCF 360 and subsequently a SIP Ack message is sent, in a step 831, from the S-CSCF 360 to the voicemail 419. In addition, the MMTel-AS 415 sends, in a step 833, a SIP 200 Ok message to the S-CSCF 360 which the S-CSCF 360 forwards, in a step 835, to the calling party 421. Reception of the SIP 200 Ok message by the calling party 421 triggers transmission, in a step 837, of a SIP Ack message to the S-CSCF 360 which the S-CSCF 360 forwards, in a step 839, to the MMTel-AS 415.

Thus, from the above it can be seen that the connection between the calling party 421 and the voicemail system 419 is now established, with the user plane traversing the media conference bridge 417. It is noted that the specific signalling protocols described above are examples only, and that departing from these protocols does not depart from the general concept of establishing a first connection between the calling party and the voicemail system.

At this point, the MMTel-AS 415 establishes a connection with the called party 413 (a second connection). This involves the establishment of another SIP session. For this SIP session, the MMTel-AS 415 is acting as a User Agent Client (“UAC”). The SIP invite may contain an indication, e.g. a URI in the “From:” header, that this call represents a real-time voicemail playout call. This connection from the MMTel-AS 415 to called party 413, to allow the called party 413 to listen in real-time to voicemail recording, is further referred to as a ‘voicemail playout call’.

The session description protocol (“SDP”) offer in the SIP Invite message sent from the MMTel-AS 415 towards the called party 413 contains an IP address and a port number of the media conference bridge 417, related to the media connection that the media conference bridge 417 has reserved for the second outgoing connection. The SDP offer also contains an indication that media shall flow in one direction only; from the media conference bridge 417 to the called party 413. The standardized SendOnly SDP attribute is used hereto.

This connection with the called party 413 is a terminating access call from the MMTel-AS 415. This connection with the called party 413 does not follow regular call handling as applicable for a connection towards the called party 413. The MMTel-AS 415 therefore establishes the connection as a terminating connection for which MMTel service triggering is suppressed. However, SCC-AS may still be triggered. SCC-AS is needed, since the called party 413 may use a VoLTE terminal or may use a GSM/3G terminal. In such case, the Terminating Access Domain Selection (“T-ADS”) functionality of SCC-AS is needed for the terminating connection towards called party 413.

When the called party 413 has answered the call, the MMTel-AS 415 updates, in a step 853, the media conference bridge 417, about the user plane details of the called party 413 (SDP answer, including IP address, port number etc.), enabling the media conference bridge 417 to send media towards the called party 413 (but not in the other direction).

Establishing the second connection in this context means that the MMTel-AS 415 sends, in a step 841, a SIP Invite message to the S-SCCF 360. This SIP message has in its “To:” header, as well as in the Request line, an identifier for the called party 413. This SIP Invite message is forwarded, in a step 843, from the S-CSCF 360 to the called party 413. In response to the reception of the SIP

Invite message by the called party 413, the called party 413 sends, in a step 845, a SIP 200 Ok message to the S-CSCF 360 which the S-CSCF 360 forwards, in a step 847, to the MMTel-AS 415. Reception of the SIP 200 Ok message by the MMTel-AS 415 triggers transmission, in a step 849, of a SIP Ack message to the S-CSCF 360 which the S-CSCF forwards, in a step 851, to the called party 413.

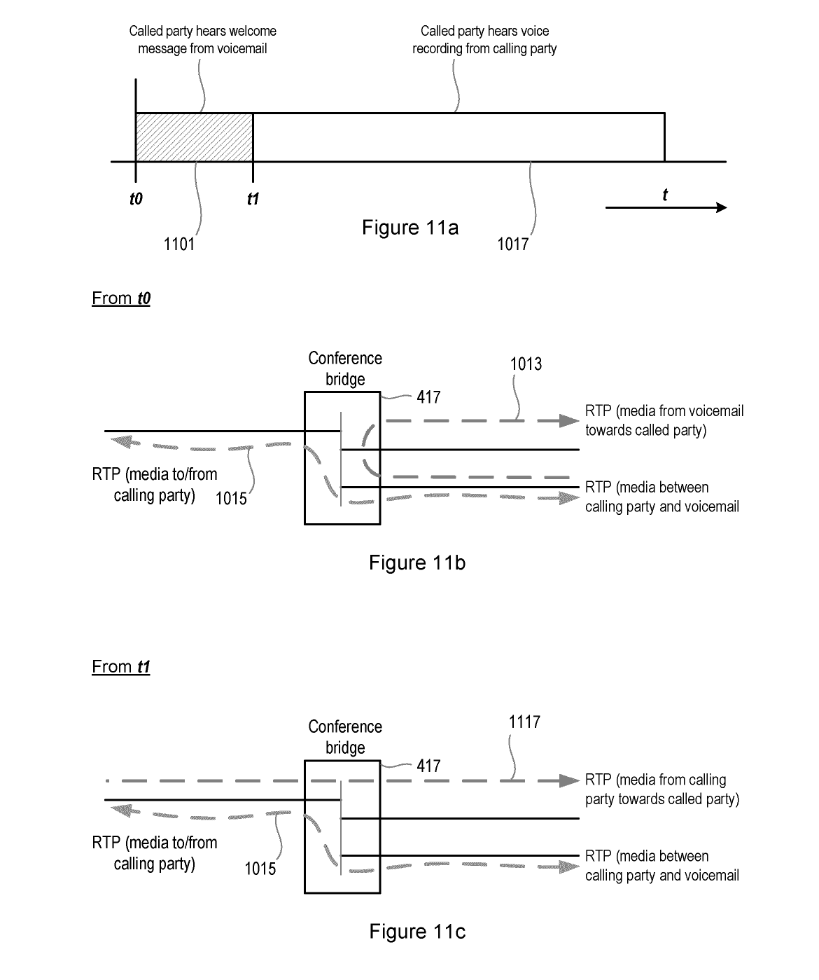

The result is that a bidirectional media connection is established 47 between the calling party 421 and the voicemail system 419, via the media conference bridge 417. In addition, a uni-directional media connection is established, the media conference bridge 417 and the called party 413. This condition involving information transfer is referenced with reference numeral 49 in FIG. 8. The media carried over this uni-directional media connection is the media received from the calling party 421. In an embodiment of the invention, this uni-directional media connection, may, before a uni-directional media connection is established between the calling party 421 and the called party 413, be used to carry media originating from the voicemail system 419, for instance a welcome message recorded by the called party 413. This embodiment will be described in more detail below with reference to FIGS. 11a to 11c.

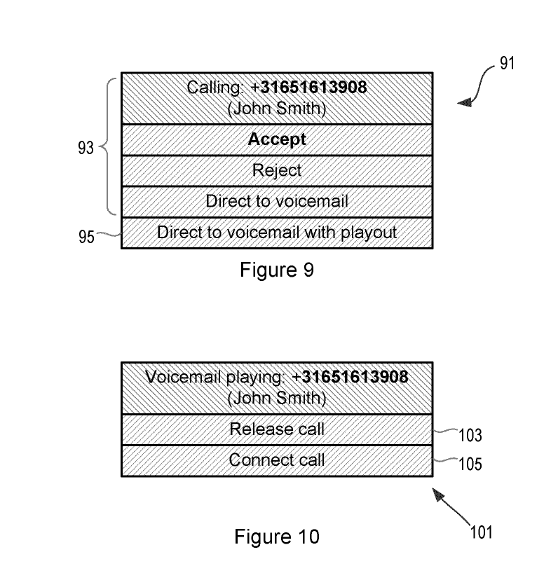

In an embodiment of the invention the SIP phone of the called party 413 is enhanced with a terminal-resident application that offers the possibility for the deflection to voicemail with real-time playout. This application may display, when a call arrives, a menu 91 as shown in FIG. 9. The menu 91 will comprise a common phone menu labelled 93 and offering the options as known by a person skilled in the art, for example indicating the calling party, and providing Accept, Reject and Direct to voicemail options. In addition, the menu 91 proposes an enhanced option labelled 95. The option “Accept” is highlighted (bold), indicating that the cursor is currently on that menu option. A user can scroll to the other options in the menu 91. The menu option where the cursor resides will be shown in bold. selecting the option “Direct to voicemail with playout” will cause the step 89 and following steps to be executed as explained above in connection with FIG. 8.

In an embodiment of the invention, the MMTel-AS 415 may take action to ensure that the called party 413 will start listening in to the speech from the calling party 421 only when recording has started. This embodiment of the invention is graphically shown in FIG. 11.

FIG. 11 a shows a graph depicting two periods:

A first period 1101 extends from t0 to t1. During this period 1101 the media conference bridge 417 connects the called party 413 with the voicemail system 419 such that a media stream (i.e. speech, voice and/or video) diffused by the voicemail system 419 (for instance the welcome message recorded by the called party in a voicemail box which the voicemail system 419 provides) is transmitted towards the called party 413. The media conference bridge 417 connects the voicemail system 419 to the calling party 421 such that media from the voicemail system 419 (e.g. playing the welcome message) is also directed towards the calling party 421. During this first period 1101, the flow of information is as shown in FIG. 11b where the connection between the called party 413 and the voicemail system 419 is referenced 1013 and the connection between the voicemail system 419 and the calling party 421 is referenced 1015.

It is an advantage not to direct during this first period 1101, through superimposition, the media stream from the calling party 421 towards the called party 413. The reason is that the calling party is not aware that what they pronounce may be heard by the called party. This condition may actually be imposed by law. i.e. for legal reason, the connecting of the speech from a calling party to a called party may not start earlier than a ‘beep’ (or other indication that a recording is about to start) has been emitted by the voicemail system 419. Precisely because prior to the ‘beep’, the calling party is not aware that what they pronounce may be heard by the called party (when the called party listens to their voicemails).

During a subsequent period 1017 starting at t1, the media conference bridge 417 connects the media stream 1117 from the calling party 421 towards the called party 413, corresponding to a second connection described above (besides forwarding the media stream 1015 from the calling party 421 also towards the voicemail system 419, corresponding to a first connection described above). This is reflected in FIG. 11c, whereby a two-way connection is shown between the calling party and the voicemail, and a uni-direction connection from the calling party to the called party.

The media stream directed to the called party 413 can thus be adapted. As depicted in FIG. 6, the MMTel-AS 415 receives an indication from the voicemail system 419 that the recording starts. This indication may e.g. be the 200 Ok final response from the voicemail system 419 (for the case that charging the calling party commences when the playing of the welcome message is complete). Or, when the MMTel-AS 415 has integrated voicemail handling the MMTel-AS 415 will receive an indication from the voicemail system 419, over the H.248 media control interface, that the playing of the welcome message is complete. The MMTel-AS 415 will then instruct the media conference bridge 417 to adapt its media connection accordingly.

Should the called party decide not to answer this real-time voicemail playout call from the MMTel-AS 415, e.g. send a SIP 480 Busy here message in response to receiving the voicemail playout call in response to the SIP Invite message of step 843 in FIG. 8, then MMTel-AS 415 does not take any further action. The connection between calling party 421 and voicemail system 419 remains established and the calling party 421 can record a voice message as normal. The user plane remains routed through the media conference bridge 417.

A first embodiment of the present invention enables a called party to listen in to voicemail whilst the voice message from the calling party is being recorded. But whilst listening to the voice message recording, the called party 413 may want to get himself connected to this call in order to start conversation with the calling party.

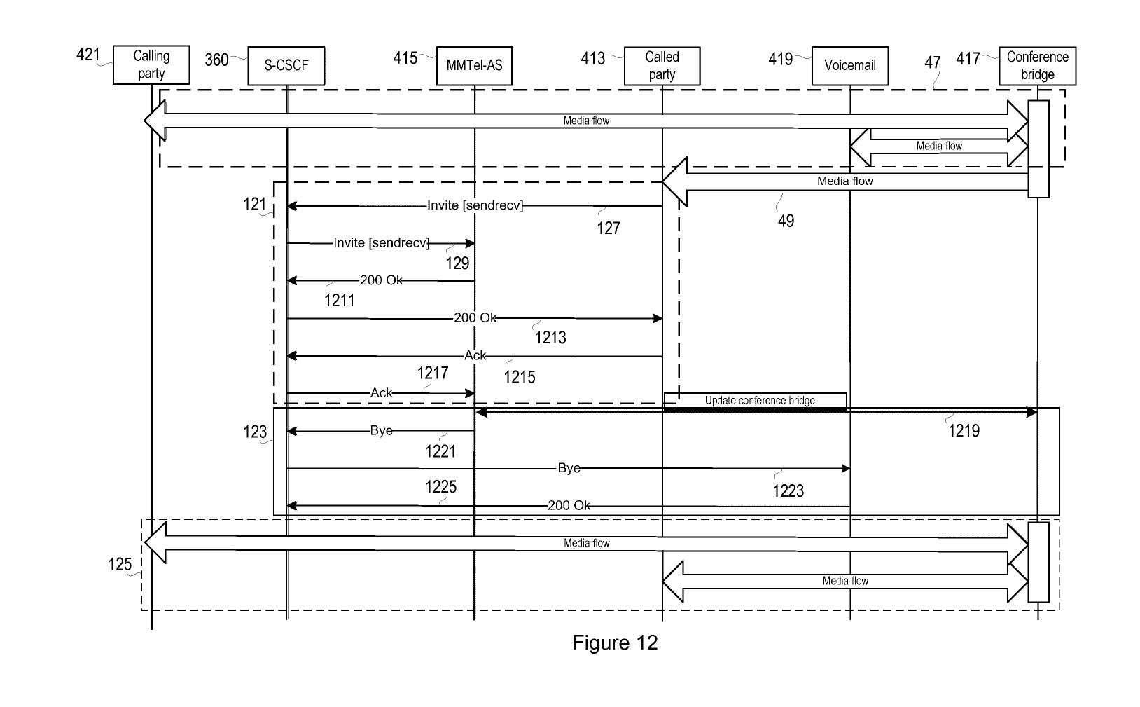

This aspect of the invention will be referred to as ‘barging in’ to the voicemail recording. This aspect overcomes the problem that the called party 413 has to wait for an undetermined period, before they can call the calling party 421 back. This aspect will be described in connection with the call flow diagram shown in FIG. 12. This diagram shows information transfer referenced 47 and 49 described in connection with FIG. 8. It will therefore be assumed that a real-time voicemail playout call is ongoing. During this call, a SIP re-Invite is sent, in a step 127, from the called party 413 to the S-CSCF 360, and from the S-CSCF sent, in a step 129, towards the MMTel-AS 415 . As the person skilled in the art will know, when an Invite transaction is used during an established SIP session, the Invite transaction is referred to as re-Invite. The syntactical name of the transaction remains, however, ‘Invite’. The SIP re-Invite message requests that the media stream be upgraded to Send and Receive. Therefore the SIP re-Invite message contains an SDP offer with attribute ‘SendRecv’.

In response to the reception of the re-Invite message, the MMTel-AS 415, sends, in a step 1211, a SIP 200 Ok message to the S-CSCF 360. Upon reception of this SIP 200 Ok message, the S-CSCF sends, in a step 1213, a SIP 200 Ok message to the called party 413. The called party 413 acknowledges receipt of this SIP 200 Ok message by sending, in a step 1215, a SIP Ack message to the S-CSCF 360. The S-CSCF 360 upon reception of this SIP Ack message, sends, in a step 1217, on its turn a SIP Ack to the MMTel 415. When the MMTel 415 has received this SIP Invite message and the associated SIP 200 Ok and Ack are transmitted and received respectively, the MMTel 415 updates, in a step 1219, the media conference bridge 417. Specifically, the MMTel 415 instructs the media conference bridge 417 to disconnect the user plane connection with the voicemail system 419 and to upgrade the connection with the called party to a bidirectional one. The MMTel 415 also releases the SIP session with the voicemail system 419. To this end the MMTel-AS 415 sends, in a step 1221, a SIP Bye message to the S-CSCF 360. The S-CSCF 360 sends, 1223, this SIP Bye message to the voicemail system 419 which responds to this SIP Bye message by sending, in a step 1225, a SIP 200 Ok message to the S-CSCF 360. The S-CSCF 360 forwards the 200 Ok message to the MMTel-AS 415, but for the sake of simplicity this step is not shown in FIG. 12.

The effect is that the call is now continuing as a bidirectional call between the calling party 421 and the called party 413. The connection with the voicemail system 419 is released. The media plane between the calling party 421 and the called party 413 still traverses the media conference bridge 417. The called party 413 may excuse themselves by stating, for example, ‘sorry, I just missed your call, but we can talk now’ to the calling party 421.

In an embodiment of the invention the SIP phone of the called party 413 is enhanced with a terminal-resident application that offers the possibility to barge in to a call. This application may cause the display of a menu 101 as shown in FIG. 10 on the screen of the SIP phone. The menu 101 will comprise several options. One possible option is labelled 103 in FIG. 10 and is to release the call. Another option (labelled 105) is to barge in to the call. The option may illustrate this for example by the text “Connect call” or “Connect to call”. Selecting this menu option has the effect that the terminal-resident application causes the SIP re-Invite message to be sent to the MMTel-AS 415 as described in steps 127 and 129 in connection with FIG. 12.

The menu shown in FIG. 10 applies when the ongoing call is a call that was established from the MMTel-AS 415 to the called party 413 as a real-time voicemail playout call. The menu option ‘Connect to call’ allows for ‘jumping’ into the call. This option is useful for real-time voicemail playout calls.

In an embodiment, of the invention the media conference bridge 417 is removed from the user plane when the called party 413 applies the barge-in. Hereto, the MMTel-AS 417 applies SDP re-negotiation between the calling party 421 and the called party 413. An SDP may thus be negotiated that corresponds to a direct media connection (user plane) between the calling party 421 and the called party 413. The MMTel-AS 415 can then release the media conference bridge 417 entirely.

The end-to-end re-negotiation of SDP between the calling party 421 and called party 413 may be done by the called party 413 sending an ‘empty re-Invite’, i.e. a SIP re-Invite message without SDP offer. The MMTel-AS 415 sends, in its turn, also an empty SIP re-Invite message towards the calling party 421. This has the effect that the calling party 421 provides a new SDP offer. This new SDP offer can be conveyed to the called party 413 in a SIP 200 OK message which is sent in response to this SIP re-Invite message.

The above-described in-call re-negotiation of SDP may conveniently be used in this embodiment of the present invention.

When the MMTel-AS 415 releases the connection with the voicemail system 419, this constitutes a regular call release for the voicemail system 419. The voicemail system 419 will, in reaction, store the recorded voicemail message and notify the called party 413, through SMS, about the missed-call and about the availability of the voicemail message, as normal and further depending on the exact behaviour of the voicemail system 419. In this case, however, the called party 413 has already listened to the voice message (recorded so far) and is aware of the ‘missed call’. So, there is no functional need for (a) storing the recorded voice message and (b) sending a missed-call notification to the called party.

Therefore, in an embodiment of the invention, the MMTel-AS 415 may include an indication in the Bye request sent in steps 1221 and 1223 from the MMTel-AS 415 to the voicemail system 419 about this specific call release situation.

The voicemail system 419 then knows that it should not store the voicemail message and that it should not send a notification to the called party 413. This indication may take the form of a Reason header, as specified in IETF RFC 3326. For example:

Reason: Q.850; cause=31; text=“purge voicemail”

The cause value 31 means ‘Normal, unspecified’. This cause value is part of class 001 cause values, as specified in ITU-T Q.850. Only a class 000 or a class 001 cause value would be suitable. Value 31 is neutral and probably the most suitable value. The text string ‘purge voicemail’ signals to the voicemail system 413 that it must purge the voicemail recorded so far.

If the voicemail system 419 resides in the CS network, then the Reason header is used to set the ISDN User Part (“ISUP”) cause value in ISUP Release message. The ISUP release will then contain ISUP cause 31. The reason-text is not copied to ISUP Release. As a result, the CS based voicemail system will not be inhibited to store the recorded voice mail.

A possibility exists that the called party 413 does not answer the voicemail playout call or that the establishment of the voicemail playout call towards the called party 413 was for any other reason not successful. In that case, the voicemail message from the calling party 421 can be stored as normal and the called party 413 can receive a voicemail message waiting alert (e.g.) as normal. Hereto, the cause value in the Bye request from MMTel-AS 415 to voicemail system 419 should be set in accordance with the call case: if the called party had answered the voicemail playout call, the cause value shall be set as described above. Otherwise, the cause value may be set as normal, or may be omitted, as appropriate for the voicemail system 419.

If the called party 413 answers the voicemail playout call after the recording of the voicemail message from the calling party 421 has started, then the voicemail system 419 stores the voicemail message, as the beginning of the voicemail message was not heard. Hereto, the MMTel-AS 415 shall in this case omit including the aforementioned Reason header in the Bye request message towards the voicemail system 419.

The methods are described above for voice calls. However, these methods may also be applied to video calls, without deviating from the object of the invention.

It should be noted that the calling party 421 can use not only a SIP phone but whatever device having SIP functionality. In addition, it is possible that the called party 413 answers the voicemail playout call on another device i.e.

another one than the one to which the call was directed, e.g. on their PC based SIP phone. If the PC based SIP phone is equally enhanced with this terminal-resident application, then when this call is accepted, it will show menus comparable to the ones shown in FIGS. 9 and 10.

If the terminal on which the called party 413 answers the voicemail playout call is not an “enhanced” terminal, the voicemail playout call will be offered to the phone, and will be presented to the user, as a normal terminating call. Similarly, if the user answers the call on the PC based SIP phone, without said terminal-resident application, the user will not be offered the option to apply barge-in into the call (whilst voice message recording is ongoing).

If the voicemail playout call is answered on a VoLTE phone with packet switched (“PS”) access, then this call may be subject to access transfer to UTRAN, Single radio voice call continuity (“SR-VCC”). When SR-VCC has taken place, the voicemail playout call will continue with circuit switched (“CS”) access.

Although in the above a description has been given for the invention applied to IMS based telephony, i.e. Multimedia telephony (MMTel), the invention may also be applied to GSM/3G or LTE phones, with the signalling protocols adapted accordingly. It may, for example, require the use of User-to-user signaling (UUS) over DTAP, in order to allow the GSM/3G terminal to apply the required signalling to and from the MSC.

The embodiments of the invention have the benefit of allowing a user of a called terminal to be informed, in real time (while a transmission of information over a first connection is in progress), of the information (e.g. speech) that is being recorded for the user by a calling party. An enhanced call deflection procedure is therefore provided, i.e. comprising voicemail+playout.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1-15. (canceled)

16. A method for enhancing communication service in a called party terminal, the method comprising the steps of:
receiving a request for establishment of a first connection with a calling party terminal;
in response to said request, sending a command for establishing said first connection between said calling party terminal and a storage entity, said command comprising a parameter for triggering the establishment of a second connection; and
receiving via said second connection information being transmitted over said first connection.

17. The method as claimed in claim 16, further comprising, in response to receiving the request for establishment of the first connection with a calling party terminal, the step of providing a user of said called party terminal with at least one call handling option for selecting said command to be sent.

18. The method as claimed in claim 16, further comprising the step of:
sending a second command for changing said second connection into a bidirectional communication with said calling party terminal.

19. The method as claimed in claim 18, wherein said second command comprises a Session Initiation Protocol, SIP, Re-Invite message.

20. The method as claimed in claim 18, further comprising the step of providing a user of said called party terminal with at least one call handling option for selecting said second command to be sent.

21. The method as claimed in claim 16, wherein said command for establishing said first connection between said calling party terminal and said storage entity comprises a Session Initiation Protocol, SIP, final response code 380 Alternative Service message comprising a designated attribute in a header or in a body of said message, said attribute indicating that a voicemail playout is required.

22. A called party terminal comprising:
a receiving unit adapted to receive a request for establishment of a first connection with a calling party terminal; and
a processing unit adapted to send, in response to receiving said request, a command for establishing said first connection between said calling party terminal and a storage entity, said command comprising a parameter for triggering the establishment of a second connection, and
wherein the receiving unit is further adapted to receive via said second connection information being transmitted over said first connection.

23. The called party terminal as claimed in claim 22, wherein, in response to receiving the request for establishment of the first connection with the calling party terminal, the processing unit is adapted to provide a user of the called party terminal with at least one call handling option for selecting the command to be sent.

24. The called party terminal as claimed in claim 22, wherein said command for establishing said first connection between said calling party terminal and said storage entity comprises a Session Initiation Protocol, SIP, final response code 380 Alternative Service message comprising a designated attribute in a header or in a body of said message, said attribute indicating that a voicemail playout is required.

25. The called party terminal as claimed in claim 22, wherein said processing unit is configured to send a second command for changing said second connection into a bidirectional communication between said called party terminal and said calling party terminal, wherein said second command comprises a Session Initiation Protocol, SIP, Re-Invite message.

26. A method comprising the steps of:
receiving a command for establishing a first connection between a calling party terminal and a storage entity, said command comprising a parameter for triggering the establishment of a second connection;
establishing said first connection; and
establishing said second connection between said calling party terminal and a called party terminal, such that said called party terminal can receive via said second connection information being transmitted over said first connection.

27. The method as claimed in claim 26, further comprising the steps of:
before establishing said second connection, establishing a connection between said storage entity and said called party terminal; and
after a predetermined period of time, releasing said connection.

28. The method as claimed in claim 26, further comprising the steps of:
receiving from said called party terminal a second command for changing said second connection into a bidirectional communication between said called party terminal and said calling party terminal; and
establishing said bidirectional communication.

29. The method as claimed in claim 28, wherein said second command comprises a Session Initiation Protocol, SIP, Re-Invite message.

30. The method as claimed in claim 26, wherein the steps of establishing the first connection and second connection comprise the steps of establishing the first connection and second connection via a bridging unit.

31. The method as claimed in claim 30, further comprising the step of establishing a direct connection between the calling party terminal and the called party terminal.

32. The method as claimed in claim 26, further comprising the step of deleting said information from said storage entity.

33. The method as claimed in claim 26, wherein said command for establishing said first connection between said calling party terminal and said storage entity comprises a Session Initiation Protocol, SIP, final response code 380 Alternative Service message comprising a designated attribute in a header or in a body of said message said attribute indicating that a voicemail playout is required.

34. An application server comprising:
a receiving unit adapted to receive a command for establishing a first connection between a calling party terminal and a storage entity, said command comprising a parameter for triggering the establishment of a second connection;
a processing unit adapted to establish said first connection;
wherein the processing unit is further adapted to establish said second connection between said calling party terminal and a called party terminal, such that said called party terminal can receive via said second connection information being transmitted over said first connection.

35. The application server as claimed in claim 34, wherein the application server is adapted to receive said command for establishing said first connection between said calling party terminal and said storage entity as a Session Initiation Protocol, SIP, final response code 380 Alternative Service message comprising a designated attribute in a header or in a body of said message, said attribute indicating that a voicemail playout is required.

36. The application server as claimed in claim 34, wherein the application server is further adapted to:
receive from said called party terminal a second command for changing said second connection into a bidirectional communication between said called party terminal and said calling party terminal; and
establish said bidirectional communication.

37. The application server as claimed in claim 36, wherein said second command comprises a Session Initiation Protocol, SIP, Re-Invite message.
